(19) United States
(12) Patent Application Publication
(10) Pub. No.: US 2014/0035927 A1
(43) Pub. Date: Feb. 6, 2014

(54) Methods, Computer Readable Media, and Apparatuses for Enabling Non-System Fonts

(71) Applicants: Michael D. BUCKLEY, Portland, OR (US); Clinton T. DAEUBLE, Portland, OR (US); Cassidy K. PATZUK-RUSSELL, Portland, OR (US); Steven J. RUSSEL, Portland, OR (US); Chadlee R. SLATER, Tigard, OR (US)

(72) Inventors: Michael D. BUCKLEY, Portland, OR (US); Clinton T. DAEUBLE, Portland, OR (US); Cassidy K. PATZUK-RUSSELL, Portland, OR (US); Steven J. RUSSEL, Portland, OR (US); Chadlee R. SLATER, Tigard, OR (US)

(73) Assignee: CELARTEM, INC., Portland, OR (US)

(21) Appl. No.: 13/566,112

(22) Filed: Aug. 3, 2012

(51) Int. Cl. G06T 11/00

(52) U.S. Cl. 345/467

(57) ABSTRACT

Methods, computer readable media, and apparatuses for enabling non-system fonts are presented. A listing of a plurality of non-system fonts may be provided within an application. Responsive to a selection of one of the plurality of non-system fonts by a user of the application, the one of the plurality of non-system fonts may be enabled within the application.

### BACKGROUND

Fonts may be provided on a computing device using one or more electronic data files that contain one or more glyphs, characters, or symbols. An operating system (OS) of a computing device may include a library of fonts, which may also be called a library of system fonts because these fonts are installed as part of the OS. System fonts can be managed by the OS and made available for use, for example, by one or more applications executing on the computing device. Users of the computing device can also install additional fonts which the OS may add to the library of system fonts.

Many users, such as graphic designers, may utilize a large number of fonts, a substantial portion of which may not be included in the library of system fonts. Such users may utilize one or more font management applications to assist them in managing this large number of fonts. For example, a font management application may track where fonts are stored, support searching through a user's font library, and assist in resolving font corruption issues. One drawback to traditional font management applications, however, is their inaccessibility from within applications (e.g., design applications) where users may desire to utilize the large number of fonts, including those fonts that are not included in the library of system fonts.

### SUMMARY

The following presents a simplified summary in order to provide a basic understanding of some aspects of the disclosure. This summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure relate to enabling non-system fonts. In some embodiments, a listing of non-system fonts may be provided within an application. Responsive to a selection of one of the non-system fonts by a user of the application, the selected non-system font may be enabled within the application. In some embodiments, enabling the selected non-system font within the application may include activating the selected non-system font within an OS on which the application is running In some embodiments, the selected non-system font may be activated globally within the OS on which the application is running Alternatively, in some embodiments, the selected non-system font may be activated for use specifically within the application. In some embodiments, enabling the selected non-system font may include installing the selected non-system font within the OS on which the application is running.

Aspects of this disclosure may also relate to notifying the application to update a system fonts menu associated with the application to include the selected non-system font.

Aspects of this disclosure may further relate to applying the selected non-system font to text within the application selected by a user of the application.

Aspects of this disclosure may also relate to providing the listing of non-system fonts within the application. In some embodiments, the listing of non-system fonts may be displayed as part of a system fonts menu associated with the application. Additionally or alternatively, the listing of non-system fonts may be displayed in a menu distinct from a system fonts menu associated with the application.

Other details and features will be described in the sections that follow.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings and in which like reference numerals refer to similar elements.

FIG. 1 illustrates an exemplary apparatus or computing device in which one or more aspects of the disclosure may be implemented.

FIG. 2 illustrates an exemplary network environment in which one or more aspects of the disclosure may be implemented.

FIGS. 3A-3C illustrate exemplary user interfaces (UIs) associated with an OS or application in which one or more aspects of the disclosure may be implemented.

FIGS. 4, 5A, and 5B illustrate one or more methods according to one or more aspects of the disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. These connections are general and, unless specified otherwise, may be direct or indirect, wired or wireless, and the disclosure is not intended to be limiting in this respect.

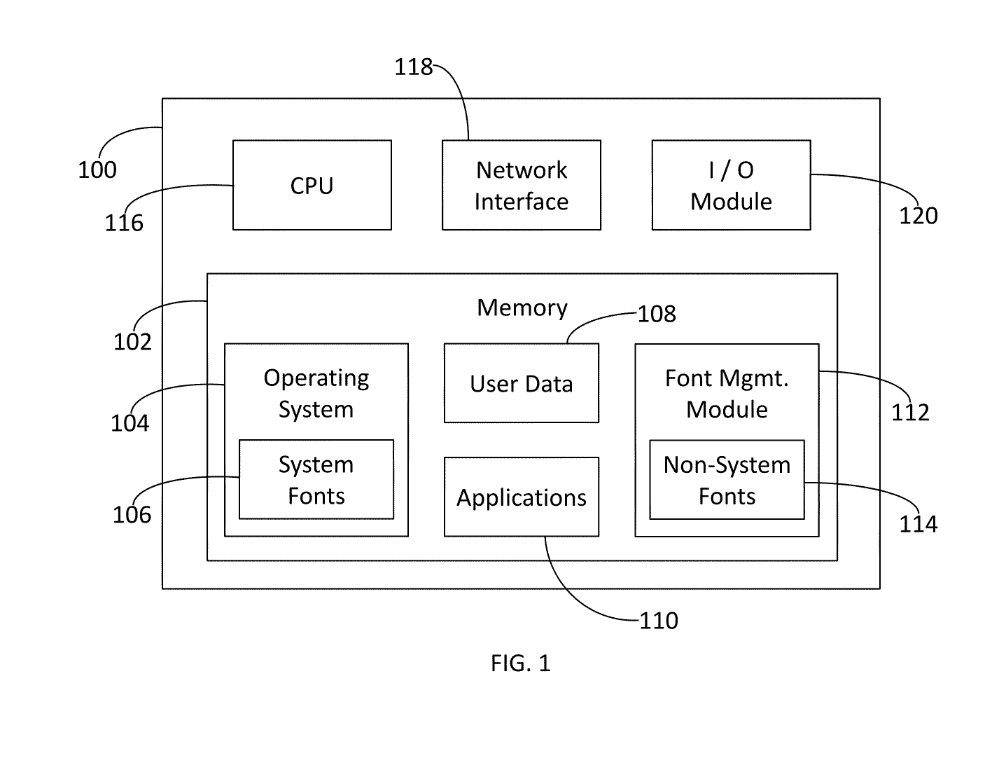

FIG. 1 illustrates an exemplary apparatus or computing device in which one or more aspects of the disclosure may be implemented. Referring to FIG. 1, in one or more configurations, one or more aspects described herein may be implemented as a computer program or a combination of computer programs for use with computer 100 and stored in memory 102. Computer 100 may be any type of computing device. For example, computer 100 may be a desktop computer, laptop computer, notebook computer, tablet computer, network server, portable computing device, personal digital assistant, smart phone, mobile telephone, distributed computing network device, or any other device having the requisite components or abilities to operate as described herein. By having the requisite components or abilities to operate as described herein, computer 100 may be configured as a special-purpose device according to one or more aspects of the disclosure.

As indicated above, computer 100 may include memory 102. Memory 102 may include volatile memory or non-volatile memory (e.g., random access memory (RAM), fixed disk, optical disk, holographic storage, removable storage media, flash drive, and the like) for temporarily or permanently storing data or instructions. For example, memory 102 may include OS 104. OS 104 may be, for example, one or more instances of MICROSOFT WINDOWS or APPLE MAC OS. Aspects of the disclosure are not limited to the specific OSs described above; rather specific examples are given merely for the purpose of illustration, the disclosure contemplating the use of any OS capable of performing aspects of the disclosure described herein. As indicated above OS 104 may include one or more system fonts 106 which may be included with OS 104, stored within OS 104, or managed by OS 104 or a font management application provided with OS 104 (e.g., APPLE MAC OS's FONT BOOK, MICROSOFT WINDOWS'S FONT, and the like). As used herein, “system font” designates a font that is managed by an OS (e.g., OS 104) or a font management application provided with an OS. Memory 102 may also include user data 108. User data 108 may include one or more files or data created or utilized by a user of computer 100. Memory 102 may also include applications 110. Applications 110 may include one or more programs or modules for execution by a user of computer 100. For example, applications 110 may include one or more design applications (e.g., ADOBE ILLUSTRATOR, ADOBE INDESIGN, ADOBE PHOTOSHOP, QUARKXPRESS, and the like).

Computer 100 may also include one or more processors. For example, computer 100 may include central processing unit (CPU) 116. CPU 116 may include one or more processors configured to execute one or more programs or modules stored in memory 102. For example, CPU 116 may be configured to execute one or more of OS 104, applications 110, or font management module 112. Computer 100 may also include network interface 118. Network interface 118 may include one or more hardware components or software components for enabling computer 100 to communicate with one or more other computing platforms via one or more networks (e.g., Internet, local area network (LAN), wide area network (WAN), personal area network (PAN), and the like). For example, network interface 118 may be one or more of an Ethernet card, a wireless network interface, a modem, or a cellular communication interface. Network interface 118 may utilize one or more protocols to manage such communications (e.g., internet protocol (IP), transmission control protocol (TCP), user datagram protocol (UDP), media access control (MAC), Ethernet, and the like). Computer 100 may further include input/output (“I/O”) module 120. I/O module 120 may be configured to receive input from a user of computer 100 or to communicate information to a user of computer 100 via one or more I/O devices (e.g., keyboard, mouse, monitor, display, printer, universal serial bus (USB) ports, serial ports, parallel ports, IEEE 1394/Firewire ports, and the like).

In accordance with one or more aspects of the disclosure, memory 102 may include one or more font management modules. For example, memory 102 may include font management module 112. Font management module 112 may include one or more modules for managing one or more non-system fonts 114. As used herein, “non-system font” designates a font that is not managed by an OS or a font management application provided with an OS, but rather is installed by a user separate from the installation of an OS or is managed by a font management application distinct from computer 100's OS 104 or a font management application provided with computer 100's OS 104. As will be described in greater detail below, font management module 112 may be configured to provide a listing of non-system fonts within an application (e.g., within one or more of applications 110). Font management module 112 may further be configured to, responsive to a selection of one of the non-system fonts by a user of the application, enable the selected non-system font within the application. For example, responsive to a selection of one of non-system fonts 114 by a user of computer 100, font management module 112 may enable the selected font within one or more of applications 110.

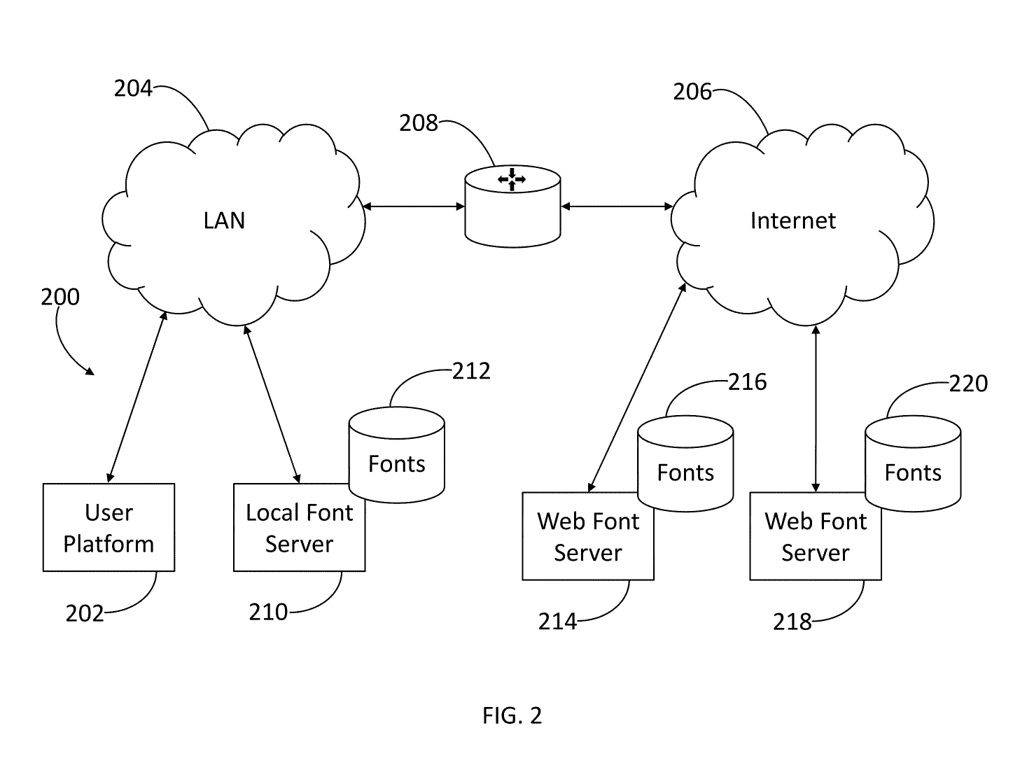

FIG. 2 illustrates an exemplary network environment in which one or more aspects of the disclosure may be implemented. Referring to FIG. 2, network environment 200 may include user platform 202. User platform 202 may include computer 100. User platform 202 may be connected to or capable of connecting to LAN 204. LAN 204 may be connected to one or more additional networks, thereby expanding the connectivity of user platform 202. For example, LAN 204 may be connected to Internet 206 via router 208. One or more of the networks within network environment 200 may include one or more font servers which may provide access to one or more font libraries. Such font libraries may include one or more non-system fonts that are not ordinarily available to a user of user platform 202 via its OS. For example, LAN 204 may be associated with an organization with which user platform 202 is affiliated (e.g., a company, university, government agency, or the like). Such an organization may have access to a font library and may utilize a font server to provide access to one or more fonts within its font library to its affiliates. For example, LAN 204 may include local font server 210 which may provide access to one or more fonts within non-system font library 212 to users such as a user of user platform 202.

Additional font libraries may be accessible to a user of user platform 202. For example, Internet 206 may include one or more font servers to which a user of user platform 202 maintains a subscription. For example, Internet 206 may include web font server 214 which may provide access to non-system font library 216. A user of user platform 202 may subscribe to one or more fonts within non-system font library 216 and web font server 214 may provide a user of user platform 202 with access to such fonts via network environment 200. Additionally or alternatively, Internet 206 may include one or more font servers which maintain publicly available font libraries (e.g., GOOGLE WEB FONTS, and the like). For example, Internet 206 may include web font server 218 which may provide public access to non-system font library 220. A user of user platform 202 may be aware of the publicly available fonts within non-system font library 220 and web font server 218 may provide a user of user platform 202 with access to such fonts via network environment 200.

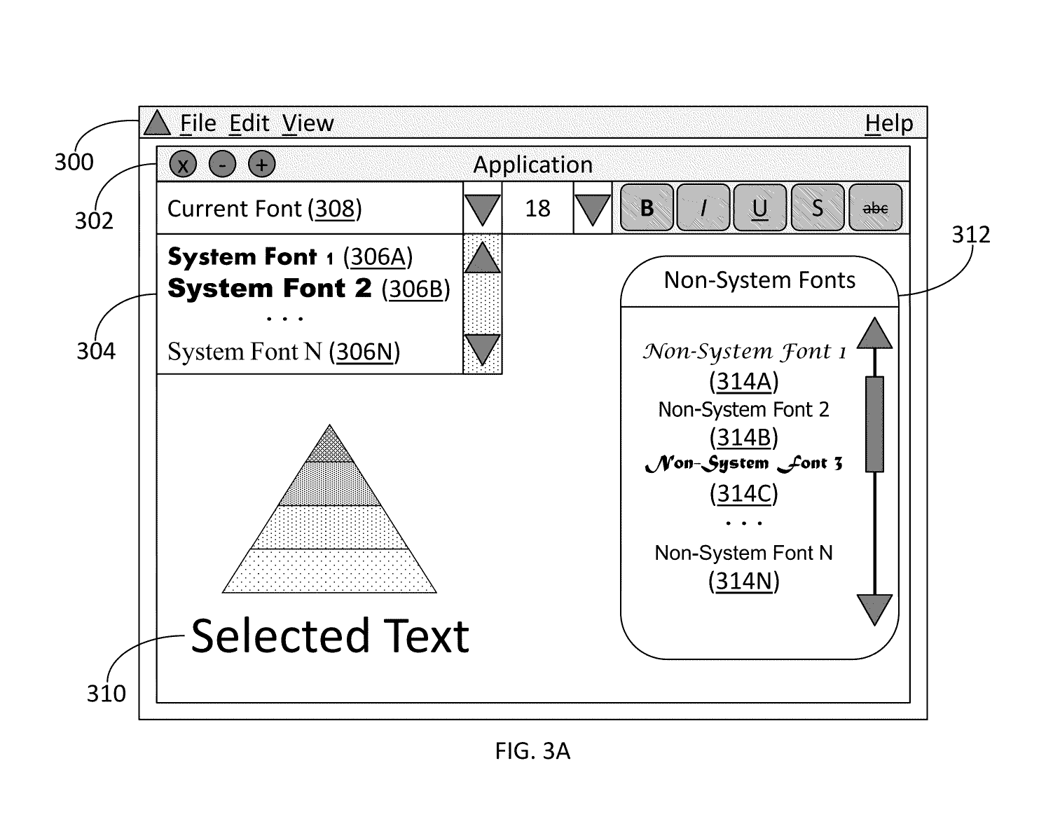

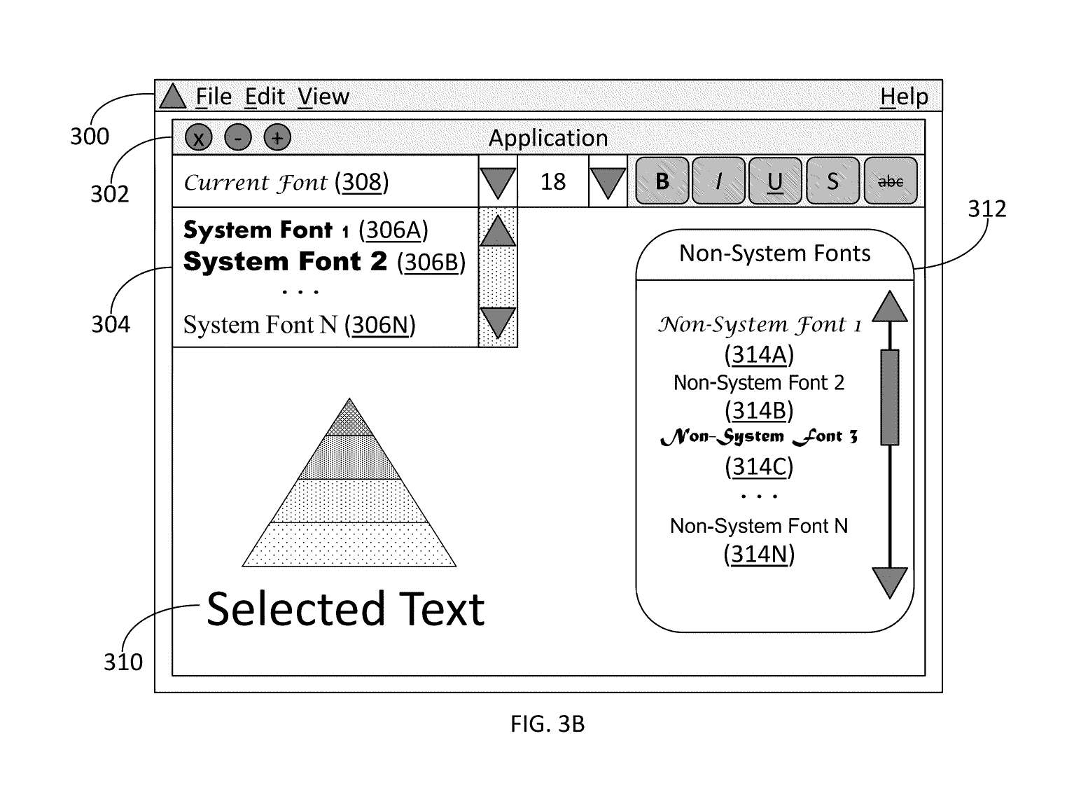

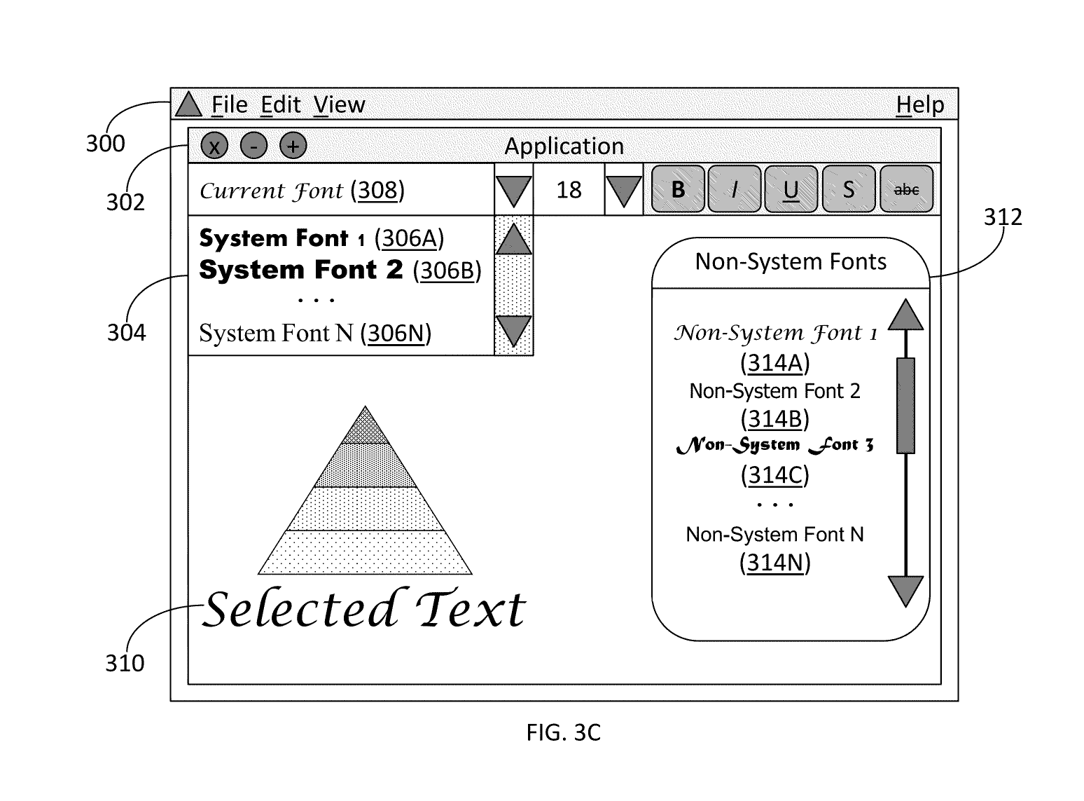

FIGS. 3A-3C illustrate exemplary UIs associated with an OS or application in which one or more aspects of the disclosure may be implemented. Referring to FIG. 3A, UI 300 may correspond to an OS UI and may be generally utilized by a user of computer 100 for communicating commands and input to OS 104, for example, via I/O module 120. UI 300 may include one or more menus (e.g., “File,” “Edit,” View,” “Help,” and the like). Such menus may include one or more options (not illustrated) which may correspond to one or more commands associated with OS 104 or one or more applications 110. UI 300 may include application UI 302. Application UI 302 may include one or more menus, toolbars, icons, buttons, and the like for communicating input or commands to one or more applications 110 associated with application UI 302.

Application UI 302 may include system fonts menu 304 for providing a listing of system fonts or commands (e.g., “bold,” “italic,” “underline,” “shadow,” “strikethrough,” and the like). As indicated above, system fonts menu 304 may include a listing of system fonts (e.g., system fonts 106). For example, system fonts menu 304 may provide a listing which includes system fonts 306A and 306B through 306N. System fonts menu 304 may indicate which of system fonts 306A and 306B through 306N is currently selected by a user. For example, system fonts menu 304 may indicate current font 308. Current font 308 may correspond to text selected within application UI 302 by a user. For example, current font 308 may correspond to selected text 310. A user may change the font of selected text 310 by selecting one of system fonts 306A or 306B through 306N. In response to such a selection, selected text 310 may be changed to the selected system font (e.g., one of system fonts 306A or 306B through 306N) and system fonts menu 304 may be updated to reflect the selected system font as current font 308.

As indicated above, in accordance with one or more aspects of the disclosure, font management module 112 may be configured to provide a listing of non-system fonts (e.g., non-system fonts 114) within an application, such as one or more of applications 110. For example, application UI 302 may correspond to one or more of applications 110 and may include a listing of non-system fonts. For example, in some embodiments, application UI 302 may include non-system fonts menu 312. Non-system fonts menu 312 may include a listing of one or more non-system fonts (e.g., non-system fonts 114). For example, non-system fonts menu 312 may include a listing of non-system fonts 314A, 314B, and 314C through 314N. In some embodiments, application UI 302 may include a listing of non-system fonts within system fonts menu 304. For example, system fonts menu 304 may be altered to include a listing of non-system fonts such as non-system fonts 314A, 314B, and 314C through 314N (not illustrated), which may be listed alongside system fonts 306A and 306B through 306N. In such embodiments, non-system fonts 314A, 314B, and 314C through 314N may be designated to distinguish themselves from system fonts 306A and 306B through 306N. In some embodiments, non-system fonts 314A, 314B, and 314C through 314N may be listed in a manner so as to be indistinguishable from system fonts 306A and 306B through 306N. In some embodiments one or more of non-system fonts 314A, 314B, and 314C through 314N or system fonts 306A and 306B through 306N may be listed in What You See Is What You Get (WYSIWYG) format to assist a user in making a font selection. In some embodiments, non-system fonts 314A, 314B, and 314C through 314N may include one or more fonts from more than one non-system font library. For example, non-system fonts 314A, 314B, and 314C through 314N may include one or more non-system fonts from one or more of non-system fonts 114 (associated with font management module 112), non-system font library 212 (associated with local font server 210), non-system font library 216 (associated with web font server 214), and non-system font library 220 (associated with web font server 218).

As indicated above, in accordance with one or more aspects of the disclosure, font management module 112 may be configured to, responsive to a selection of one of the listed non-system fonts, enable the selected non-system font within the application. For example, a user of computer 100 may desire to utilize one of non-system fonts 314A, 314B, and 314C through 314N (e.g., non-system font 314A) with respect to selected text 310. Such a user may, for example, select non-system font 314A from non-system fonts menu 312. In response to such a selection, font management module 112 may enable non-system font 314A for use within one or more of applications 110. In some embodiments, enabling non-system font 314A for use within one or more of applications 110 may include activating non-system font 314A within OS 104. In some embodiments, non-system font 314A may be activated within OS 104 globally (i.e., non-system font 314A may be activated within OS 104 for use in any application that is capable of utilizing non-system font 314A and is running on OS 104). In some embodiments, non-system font 314A may be activated within OS 104 on an application-specific basis. For example, non-system font 314A may be activated for use only within one or more of applications 110 (e.g., one or more of applications 110 that corresponds to application UI 302). In some embodiments, activating non-system font 314A within OS 104 may include font management module 112 making one or more Application Program Interface (API) calls to OS 104. For example, such API calls may include information indicating where non-system font 314A is stored and whether non-system font 314A should be activated globally or on an application-specific basis, and, if on an application-specific basis, for which specific applications. In some embodiments, enabling non-system font 314A may include installing non-system font 314A within OS 104. For example, non-system font 314A may reside in a remote location (e.g., in non-system font library 220) and font management module 112 may retrieve non-system font 314A from non-system font library 220 via web font server 218 and install non-system font 314A within OS 104. It will be appreciated, that installing non-system font 314A within OS 104 may not require physically storing non-system font 314A alongside system fonts 106. Rather, non-system font 314A may be physically stored anywhere within memory 102 (e.g., alongside non-system fonts 114) and font management module 112 may store one or more records indicating where non-system font 314A is stored.

Referring to FIG. 3B, having enabled non-system font 314A, font management module 112 may notify one or more of applications 110 of the availability of non-system font 314A. For example, font management module 112 may make one or more API calls to one or more of applications 110 indicating the availability of non-system font 314A. In response to such a notification, one or more of applications 110 (e.g., one or more of applications 110 associated with application UI 302) may update one or more of system fonts menu 304 and non-system fonts menu 312 to reflect the availability or selection of non-system font 314A. For example, system fonts menu 304 may update current font 308 to reflect that the current font is non-system font 314A. Referring to FIG. 3C, font-management module 112 or one or more of applications 110 (e.g., one or more of applications 110 associated with application UI 302) may apply non-system font 314A to selected text 310. In some embodiments, font management module 112 may make one or more API calls to one or more of applications 110 indicating that non-system font 314A should be applied to selected text 310.

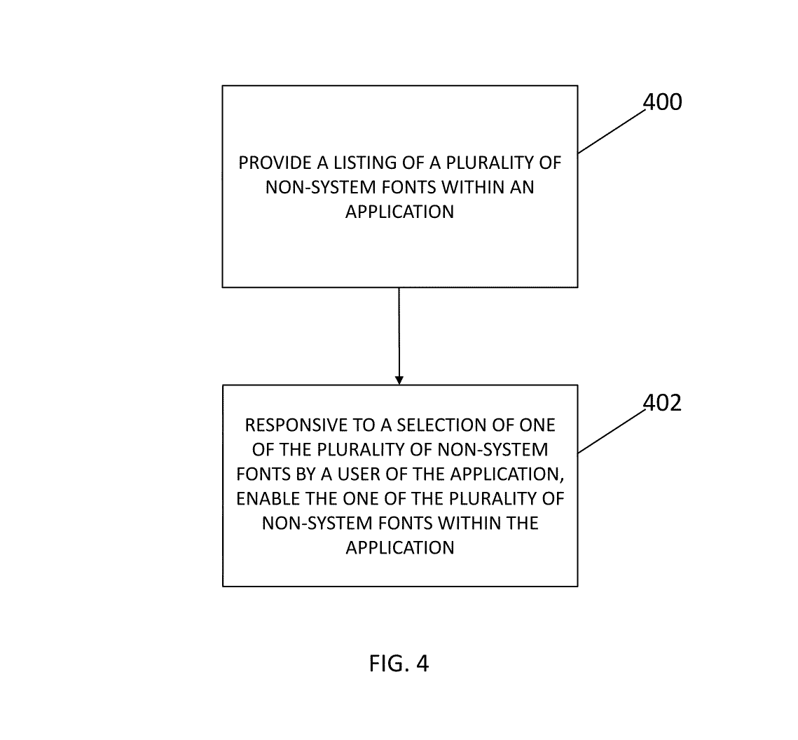

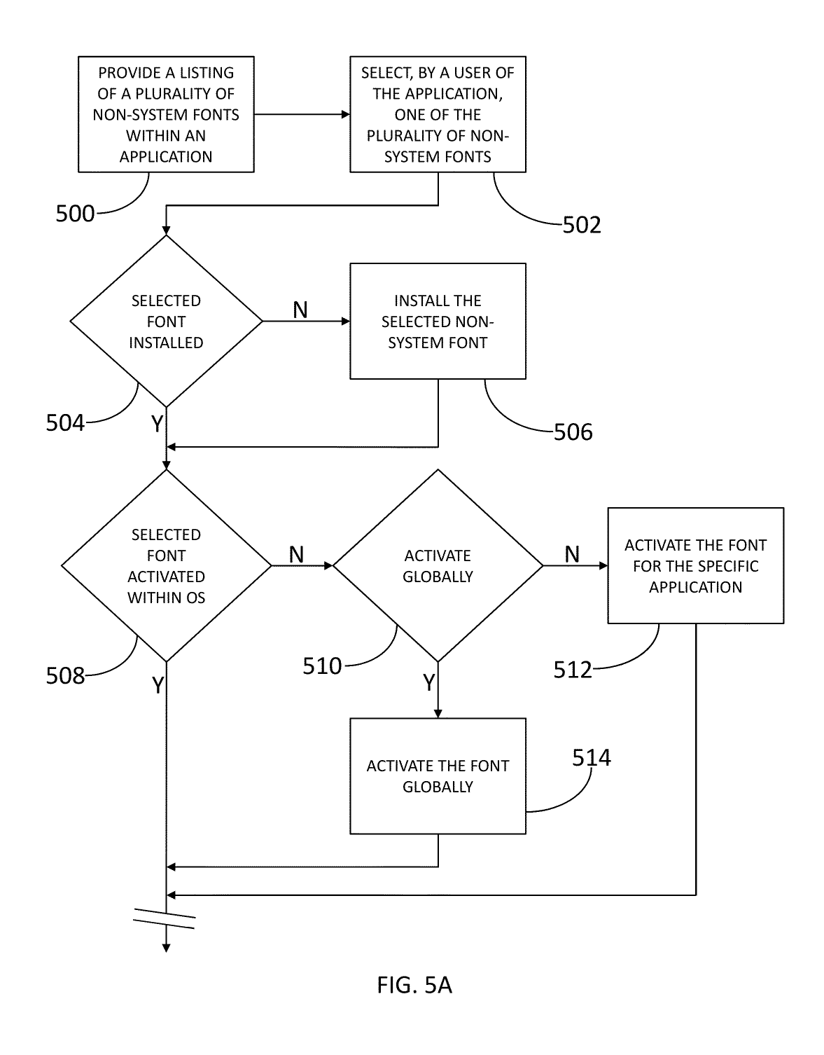

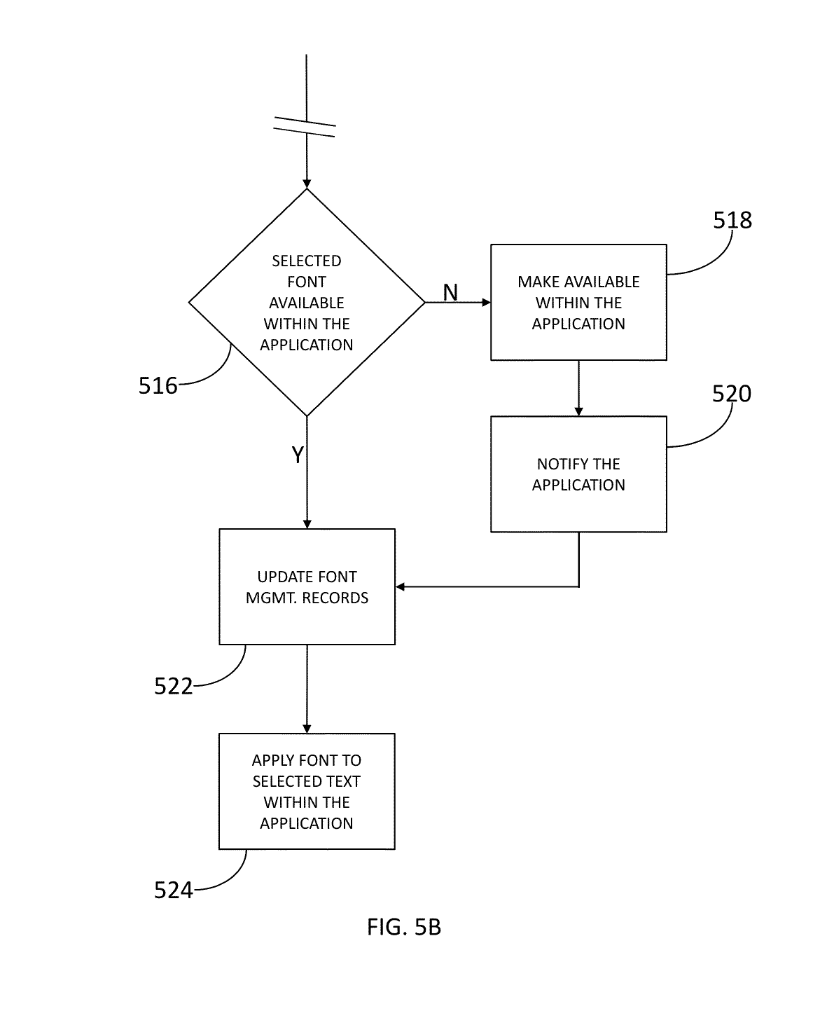

FIGS. 4, 5A, and 5B illustrate one or more methods according to one or more aspects of the disclosure.

Referring to FIG. 4, at step 400 a listing of a plurality of non-system fonts may be provided within an application. For example, font management module 112 may provide a listing of non-system fonts 314A, 314B, and 314C through 314N within one of applications 110 corresponding to application UI 302 via non-system font menu 312. At step 402, responsive to a selection of one of the plurality of non-system fonts by a user of the application, the one of the plurality of non-system fonts may be enabled within the application. For example, a user of computer 100 may select non-system font 314A from non-system font menu 312 and font management module 112 may enable non-system font 314A within the one of applications 110 corresponding to application UI 302.

Referring to FIG. 5A, at step 500 a listing of a plurality of non-system fonts may be provided within an application. For example, font management module 112 may provide a listing of non-system fonts 314A, 314B, and 314C through 314N within one of applications 110 corresponding to application UI 302 via non-system font menu 312. At step 502, a user of the application may select one of the plurality of non-system fonts. For example, a user of computer 100 may select non-system font 314A from non-system font menu 312. At step 504 a determination may be made as to whether the selected non-system font is installed. For example, font management module 112 may determine whether non-system font 314A is installed. In response to determining that the selected non-system font is not installed, at step 506, the selected non-system font may be installed. For example, in response to font management module 112 determining that non-system font 314A is not installed, font management module 112 may install non-system font 314A and the method may proceed to step 508. In response to determining that the selected non-system font is installed, the method may proceed to step 508. For example, font management module 112 may determine that non-system font 314A is installed and the method may proceed to step 508. At step 508, a determination may be made as to whether the selected non-system font is activated within the OS. For example, font management module 112 may determine whether non-system font 314A is activated within OS 104. In response to determining that the selected non-system font is not activated within the OS, at step 510, a determination may be made as to whether the selected non-system font should be activated globally or on an application-specific basis. For example, font management module 112 may determine that non-system font 314A is not activated within OS 104 and a determination may be made as to whether non-system font 314A should be activated globally within OS 104 or on an application specific basis (e.g., activated specifically for one or more of applications 110 associated with application UI 302). In response to determining that the selected non-system font should be activated on an application-specific basis, at step 512, the selected non-system font may be activated for one or more applications and the method may proceed to step 516. For example, in response to font management module 112 determining that non-system font 314A should be activated for one or more of applications 110 associated with application UI 302, font management module 112 may activate non-system font 314A for the one or more of applications 110 associated with application UI 302 and the method may proceed to step 516. In response to determining that the selected non-system font should be activated globally, at step 514, the selected non-system font may be activated globally and the method may proceed to step 516. For example, in response to font management module 112 determining that non-system font 314A should be activated globally within OS 104, font management module 112 may activate non-system font 314A globally within OS 104 and the method may proceed to step 516. Returning to step 508, in response to determining that the selected non-system font is activated within the OS, the method may proceed to step 516.

Referring to FIG. 5B, at step 516, a determination may be made as to whether the selected non-system font is available within the application. For example, font management module 112 may determine whether non-system font 314A is available within one or more of applications 110 associated with application UI 302. In response to determining that the selected non-system font is not available within the application, at step 518, the selected non-system font may be made available within the application; at step 520, the application may be notified of the availability of the selected non-system font; and the method may proceed to step 522. For example, in response to font management module 112 determining that non-system font 314A is not available within the one or more of applications 110 associated with application UI 302, font management module 112 may make non-system font 314A available within the one or more of applications 110 associated with application UI 302 and font management module 112 may notify the one or more of applications 110 associated with application UI 302 that non-system font 314A is available. In response to determining that the selected non-system is available within the application, the method may proceed to step 522. For example, in response to font management module 112 determining that non-system font 314A is available within the one or more of applications 110 associated with application UI 302, the method may proceed to step 522. At step 522, one or more font management records may be updated to reflect the selection, installation, activation, or availability of the selected non-system font. For example, font management module 112 may update one or more font management records associated with non-system font 314A to reflect that non-system font 314A was selected by a user of computer 100, is installed alongside non-system fonts 114, is activated (e.g., globally within OS 104 or on an application-specific basis for the one or more of applications 110 associated with application UI 302), or available within the one or more of applications 110 associated with application UI 302. At step 524, the selected non-system font may be applied to selected text within the application. For example, font management module 112 may apply non-system font 314A to selected text 310 within the one or more of applications 110 associated with application UI 302.

One or more aspects of the disclosure may be embodied in computer-usable data or computer-executable instructions, such as in one or more program modules, executed by one or more computers or other devices to render one or more fonts for output on a device such as a display or a printer. Generally, program modules include routines, programs, objects, components, data structures, etc. that perform particular tasks or implement particular abstract data types when executed by one or more processors in a computer or other data processing device. The computer-executable instructions may be stored on a computer-readable medium such as a hard disk, optical disk, removable storage media, solid state memory, RAM, etc. As will be appreciated, the functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Although not required, one of ordinary skill in the art will appreciate that various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more transitory or non-transitory computer-readable media.

As described herein, the various methods and acts may be operative across one or more computing servers and one or more networks. The functionality may be distributed in any manner, or may be located in a single computing device (e.g., a server, a client computer, etc.).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A method, comprising:
providing a listing of a plurality of non-system fonts within an application; and
responsive to a selection of one of the plurality of non-system fonts by a user of the application, enabling the one of the plurality of non-system fonts within the application.

2. The method of claim 1, wherein enabling the one of the plurality of non-system fonts within the application comprises activating the one of the plurality of non-system fonts within an operating system on which the application is running

3. The method of claim 2, wherein activating the one of the plurality of non-system fonts within the operating system on which the application is running comprises activating the one of the plurality of non-system fonts globally within the operating system on which the application is running

4. The method of claim 2, wherein activating the one of the plurality of non-system fonts within the operating system on which the application is running comprises activating the one of the plurality of non-system fonts on an application specific basis for use specifically within the application.

5. The method of claim 1, wherein enabling the one of the plurality of non-system fonts within the application comprises installing the one of the plurality of non-system fonts within an operating system on which the application is running

6. The method of claim 1, wherein providing the listing of the plurality of non-system fonts within the application comprises displaying the listing of the plurality of non-system fonts as part of a system fonts menu associated with the application.

7. The method of claim 1, wherein providing the listing of the plurality of non-system fonts within the application comprises displaying the listing of the plurality of non-system fonts in a menu distinct from a system fonts menu associated with the application.

8. The method of claim 1, further comprising notifying the application to update a system fonts menu associated with the application to include the one of the plurality of non-system fonts.

9. The method of claim 1, further comprising applying the one of the plurality of non-system fonts to text within the application selected by the user of the application.

10. The method of claim 1, wherein the one of the plurality of non-system fonts is a font distinct from one or more fonts provided with an operating system on which the application is running

11. One or more non-transitory computer-readable media having instructions stored thereon, that when executed by one or more computers, cause the one or more computers to perform:
providing a listing of a plurality of non-system fonts within an application; and
responsive to a selection of one of the plurality of non-system fonts by a user of the application, enabling the one of the plurality of non-system fonts within the application.

12. The one or more non-transitory computer-readable media of claim 11, wherein enabling the one of the plurality of non-system fonts within the application comprises activating the one of the plurality of non-system fonts within an operating system on which the application is running

13. The one or more non-transitory computer-readable media of claim 12, wherein activating the one of the plurality of non-system fonts within the operating system on which the application is running comprises activating the one of the plurality of non-system fonts globally within the operating system on which the application is running

14. The one or more non-transitory computer-readable media of claim 12, wherein activating the one of the plurality of non-system fonts within the operating system on which the application is running comprises activating the one of the plurality of non-system fonts on an application specific basis for use specifically within the application.

15. The one or more non-transitory computer-readable media of claim 11, wherein enabling the one of the plurality of non-system fonts within the application comprises installing the one of the plurality of non-system fonts within an operating system on which the application is running

16. The one or more non-transitory computer-readable media of claim 11, wherein providing the listing of the plurality of non-system fonts within the application comprises displaying the listing of the plurality of non-system fonts as part of a system fonts menu associated with the application.

17. The one or more non-transitory computer-readable media of claim 11, wherein providing the listing of the plurality of non-system fonts within the application comprises displaying the listing of the plurality of non-system fonts in a menu distinct from a system fonts menu associated with the application.

18. The one or more non-transitory computer-readable media of claim 11, wherein the instructions, when executed by the one or more computers, cause the one or more computers to perform notifying the application to update a system fonts menu associated with the application to include the one of the plurality of non-system fonts.

19. The one or more non-transitory computer-readable media of claim 11, wherein the instructions, when executed by the one or more computers, cause the one or more computers to perform applying the one of the plurality of non-system fonts to text within the application selected by the user of the application.

20. An apparatus, comprising:
at least one processor; and
memory storing instructions that, when executed by the at least one processor, cause the apparatus to perform:
providing a listing of a plurality of non-system fonts within an application; and
responsive to a selection of one of the plurality of non-system fonts by a user of the application, enabling the one of the plurality of non-system fonts within the application.
